(19) United States
(12) Patent Application Publication
(10) Pub. No.: US 2023/0267724 A1
(43) Pub. Date: Aug. 24, 2023

(54) DEVICE AND METHOD FOR TRAINING A MACHINE LEARNING MODEL FOR GENERATING DESCRIPTOR IMAGES FOR IMAGES OF OBJECTS

(71) Applicant: Robert Bosch GmbH, Stuttgart (DE)

(72) Inventors: Christian Graf, Muenchen (DE); Andras Gabor Kupcsik, Herrenberg (DE); David Adrian, Stuttgart (DE)

(21) Appl. No.: 18/167,242

(22) Filed: Feb. 10, 2023

(30) Foreign Application Priority Data
Feb. 18, 2022 (DE) 10 2022 201 719.6

(51) Int. Cl. G06V 10/82; G06T 3/00; G06T 3/60; G06T 7/70; B25J 9/16

(52) U.S. Cl. CPC G06V 10/82; G06T 3/0006; G06T 3/60; G06T 7/70; B25J 9/1664; G06T 2207/20081; G06T 2207/20132

(57) ABSTRACT

A method for training a machine learning model for generating descriptor images for images of one or more objects. The method includes recording multiple camera images, each showing one or more objects, and, for each camera image, generating one or more augmented versions of the camera image by applying a respective augmentation to the camera image for each augmented version of the camera image, wherein the augmentation comprises a change in position of pixel values of the camera image, generating pairs of training images each including the camera image and an augmentation of the camera image or two augmented versions of the camera image; and training the machine learning model with contrastive loss using the pairs of training images.

### CROSS REFERENCE

The present application claims the benefit under 35 U.S.C. § 119 of German Patent Application No. DE 10 2022 201 719.6 filed on Feb. 18, 2022, which is expressly incorporated herein by reference in its entirety.

### FIELD

The present disclosure relates to devices and methods for training a machine learning model for generating descriptor images for images of objects.

### BACKGROUND INFORMATION

In order to enable flexible production or processing of the objects by a robot, it is desirable for the robot to be able to handle an object regardless of the position in which the object is placed in the workspace of the robot. The robot should therefore be able to recognize which parts of the object are in which positions, so that it can, for instance, grab the object at the correct location, for example to fasten or weld it to another object. This means that the robot should be able to recognize the pose (position and orientation) of the object, for example from one or more images recorded by a camera attached to the robot, or determine the position of locations for picking up or processing. One approach to achieving this is determining descriptors, i.e., points (vectors) in a predefined descriptor space, for parts of the object (i.e. pixels of the object represented in an image plane), wherein the robot is trained to assign the same descriptors to the same parts of an object regardless of a current pose of the object and thus recognize the topology of the object in the image, so that it is then known, for example, where which corner of the object is located in the image. Knowing the pose of the camera then makes it possible to infer the pose of the object. The recognition of the topology can be realized with a machine learning model that is trained accordingly.

One example of this is the dense object net described in the paper “Dense Object Nets: Learning Dense Visual Object Descriptors By and For Robotic Manipulation” by Peter Florence et al. (hereinafter referred to as “Reference 1”). The dense object net here is trained in a self-supervised manner, wherein a dedicated arrangement with an RGBD camera (RGB plus depth) and a robot arm is used to collect training data. Multiple images are recorded from different perspectives of the same object arrangement. This is relatively time-consuming and requires an elaborate arrangement with a moving camera. More efficient approaches for training a dense object net are therefore desirable.

### SUMMARY

According to various embodiments of the present invention, a method for training a machine learning model for generating descriptor images for images of one or more objects is provided, which comprises recording multiple camera images, wherein each camera image shows one or more objects. For each camera image, the method comprises: generating one or more augmented versions of the camera image by applying a respective augmentation to the camera image for each augmented version of the camera image, wherein the augmentation comprises a change in position of pixel values (and optionally a change in color value of pixel values) of the camera image, generating one or more pairs of training images, which each include the camera image and an augmentation of the camera image or two augmented versions of the camera image, and determining, for each pair of training images, according to the change in position of pixel values included in the augmentation with which the augmented version was generated, if the pair of training images includes an augmented version of the camera image, or according to the changes in position of pixel values included in the two augmentations with which the augmented versions were generated, if the pair of training images includes two augmented versions of the camera image, from pixels of the pair of training images which correspond to one another and pixels of the pair of training images which do not correspond to one another. The method also comprises training the machine learning model with contrastive loss using the pairs of training images wherein descriptor values which are generated by the machine learning model for pixels which correspond to one another are used as positive pairs and descriptor values which are generated by the machine learning model for pixels which do not correspond to one another are used as negative pairs.

The above-described method enables a significantly simplified collection of training data and therefore a significantly less complex training of a machine learning model for generating descriptor images than, for instance, the approach of Reference 1, since, for example, only one static RGB or RGB-D camera is needed to generate the training data. Only one image has to be recorded for a scene (object configuration), which makes it easier to generate a diverse training data set suitable for training the machine learning model.

Various embodiment examples of the present invention are provided in the following.

Embodiment example 1 is a method for controlling a robot as described above.

Embodiment example 2 is the method according to embodiment example 1, wherein the augmentation comprises a rotation, a perspective transformation and/or an affine transformation.

Such augmentations enable the generation of a rich training data set and at the same time enable simple and reliable determination of pixels which correspond to one another.

Embodiment example 3 is the method according to embodiment example 1 or 2, comprising, prior to generating the augmented versions and the pairs of training images, cropping the camera images taking into account object masks of the one or more objects.

This reduces the amount of input data for training (in particular for generating the augmented versions of the camera images).

Embodiment example 4 is the method according to any one of embodiment examples 1 to 3, wherein the machine learning model is a neural network.

In other words, a dense object net is trained. Good results for generating descriptor images can be achieved with these.

Embodiment example 5 is the method according to any one of embodiment examples 1 to 4, wherein the multiple camera images are recorded from the same perspective.

This simplifies the recording of the camera images and a stationary, e.g., permanently mounted, camera can be used, for example.

Embodiment example 6 is a method for controlling a robot to pick up or process an object, comprising training a machine learning model according to any one of embodiment examples 1 to 5, recording a camera image which shows the object in a current control scenario, feeding the camera image to the machine learning model to generate a descriptor image, determining the position of a location for picking up or processing the object in the current control scenario from the descriptor image and controlling the robot according to the determined position.

Embodiment example 7 is the method according to embodiment example 6, comprising identifying a reference location in a reference image, determining a descriptor of the identified reference location by feeding the reference image to the machine learning mode, determining the position of the reference location in the current control scenario by searching for the determined descriptor in the descriptor image generated from the camera image and determining the position of the location for picking up or processing the object in the current control scenario from the determined position of the reference location.

Embodiment example 8 is a control unit configured to carry out a method according to any one of embodiment examples 1 to 7.

Embodiment example 9 is a computer program comprising instructions that, when executed by a processor, cause said processor to carry out a method according to any one of embodiment examples 1 to 7.

Embodiment example 10 is a computer-readable medium which stores instructions that, when executed by a processor, cause said processor to carry out a method according to any one of embodiment examples 1 to 7.

In the figures, like reference signs generally refer to the same parts throughout the different views. The figures are not necessarily to scale, wherein emphasis is instead generally placed on representing the principles of the present invention. In the following description, various aspects are described with reference to the figures.

### BRIEF DESCRIPTION OF THE DRAWINGS

FIG. 1 shows a robot according to an example embodiment of the present invention.

FIG. 2 shows a diagram illustrating a flow of data for training a machine learning model for generating descriptor images for images of one or more objects, according to one example embodiment of the present invention.

FIG. 3 shows two training data images according to one example embodiment of the present invention.

FIG. 4 shows a flowchart depicting a method for training a machine learning model for generating descriptor images for images of one or more objects, according to one example embodiment of the present invention.

### DETAILED DESCRIPTION OF EXAMPLE EMBODIMENTS

The following detailed description relates to the figures, which, for clarification, show specific details and aspects of this disclosure in which the present invention can be implemented.

Other aspects can be used, and structural, logical, and electrical changes can be made without departing from the scope of protection of the invention. The various aspects of this disclosure are not necessarily mutually exclusive since some aspects of this disclosure can be combined with one or more other aspects of this disclosure to form new aspects.

Different examples will be described in more detail in the following.

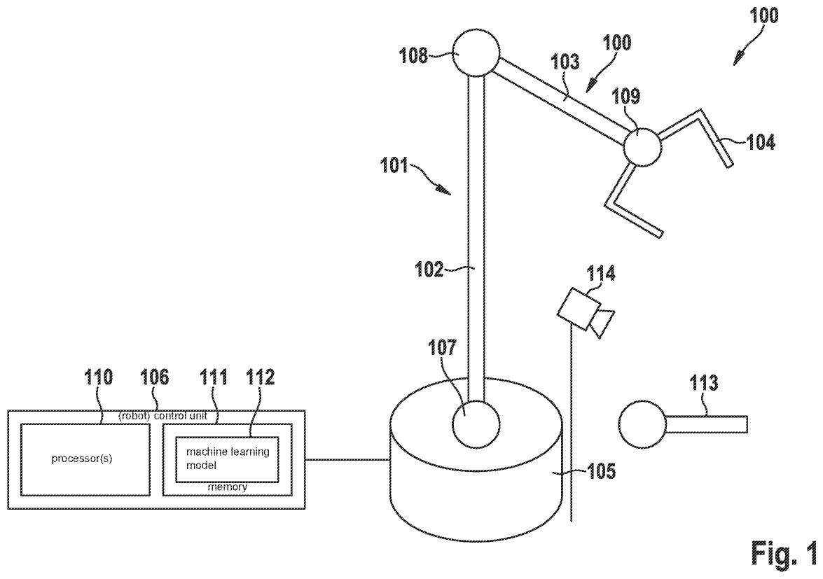

FIG. 1 shows a robot 100.

The robot 100 includes a robot arm 101, for example an industrial robot arm for handling or assembling a workpiece (or one or more other objects). The robot arm 101 includes manipulators 102, 103, 104 and a base (or support) 105 by means of which the manipulators 102, 103, 104 are supported. The term “manipulator” refers to the movable components of the robot arm 101, the actuation of which enables physical interaction with the environment, e.g. in order to carry out a task. For control, “the robot 100 includes a (robot) control unit 106 designed to implement the interaction with the environment according to a control program. The last component 104 (which is furthest from the support 105) of the manipulators 102, 103, 104 is also referred to as the end effector 104 and can include one or more tools, such as a welding torch, gripping tool, painting device, or the like.

The other manipulators 102, 103 (which are closer to the support 105) can form a positioning device so that, together with the end effector 104, the robot arm 101 is provided with the end effector 104 at its end. The robot arm 101 is a mechanical arm that can provide functions similar to those of a human arm (possibly with a tool at its end).

The robot arm 101 can include articulation elements 107, 108, 109 which connect the manipulators 102, 103, 104 to one another and to the support 105. An articulation element 107, 108, 109 can comprise one or more articulation joints that can each provide a rotary movement (i.e. rotational movement) and/or translational movement (i.e. displacement) for associated manipulators relative to one another. The movement of the manipulators 102, 103, 104 can be initiated by means of actuators controlled by the control unit 106.

The term “actuator” can be understood to mean a component that is configured to effect a mechanism or process in reaction to being driven. The actuator can implement instructions (the so-called activation) created by the control unit 106 into mechanical movements. The actuator, e.g. an electromechanical converter, can be designed to convert electrical energy into mechanical energy in reaction to being driven.

The term “control unit” can be understood to mean any type of logic-implementing entity that can, for example, include a circuit and/or a processor capable of executing software, firmware, or a combination thereof stored in a storage medium, and can issue instructions, e.g. in the present example to an actuator. The control unit can, for example, be configured using program code (e.g. software), to control the operation of a system; in the present example a robot.

In the present example, the control unit 106 includes one or more processors 110 and a memory 111 that stores code and data on the basis of which the processor 110 controls the robot arm 101.

According to various embodiments, the control unit 106 controls the robot arm 101 on the basis of a machine learning model 112 stored in the memory 111.

The control unit 106 uses the machine learning model 112 to determine the pose of an object 113 positioned in a workspace of robot arm 101, for example. Depending on the determined pose, the control unit 106 can, for example, decide which location of the object 113 the end effector 109 should grab (or process in some other way).

The control unit 106 determines the pose using the machine learning model 112 using one or more camera images of the object 113. The robot 100 can be equipped with one or more cameras 114, for example, that allow it to record images of its workspace. The camera 114 is attached to the robot arm 101, for example, so that the robot can record images of the object 113 from different perspectives by moving the robot arm 101 around. It is, however, also possible to provide one or more fixed cameras.

According to various embodiments, the machine learning model 112 is a (deep) neural network that generates a feature map for a camera image, e.g. in the form of an image in a feature space, that makes it possible to assign points in the (2D) camera image to points of the (3D) object.

The machine learning model 112 can, for example, be trained to assign a specific corner of the object a specific (unique) feature value (also referred to as a descriptor value) in the feature space. If a camera image is then fed to the machine learning model 112 and the machine learning model 112 assigns this feature value to a point in the camera image, it can be inferred that the corner is situated at this location (i.e. at a location in the space, the projection of which onto the plane of the camera corresponds to the point in the camera image). Knowing the position of multiple points of the object in the camera image makes it possible to determine the pose of the object in space.

The machine learning model 112 has to be appropriately trained for this task.

One example of a machine learning model 112 for object detection is a dense object net. A dense object net maps an image (e.g. an RGB image I∈ [symbol] ^{H×W×3} provided by the camera 114) to an arbitrary dimensional (dimension D, e.g. D=16) descriptor space image (also referred to as a descriptor image) I_{D}∈ [symbol] ^{H×W×D}; i.e. each pixel is assigned a descriptor value. The dense object net is a neural network trained using self-supervised learning to output a descriptor space image for an input image of an image. This allows images of known objects (or also unknown objects) to be mapped to descriptor images containing descriptors that identify locations on the objects independent of the perspective of the image. This provides a consistent representation of objects that can be used as the basis for control, e.g. for manipulating of objects.

A DON can be trained in a self-supervised manner by using contrastive learning.

In the self-supervised training described in Reference 1, a scene is captured from different positions and angles using a registered RGB-D camera on a robot arm. Since the orientation of the camera is known, the geometric correspondences between two of these images form a set of pixels which correspond to one another and which do not correspond to one another. The training data consists of these sets of matching and non-matching pixels along with the RGB images. A specific camera calibration is required, as is a sophisticated data acquisition procedure in which the camera mounted on the robot captures the scene from different viewing angles. The object representation can be used to identify key points on an object, for example.

Collecting the training data for the training according to Reference 1 is thus relatively complex, since it requires an arrangement with a movable camera and images have to be recorded from different perspectives.

According to various embodiments, a method for training a machine learning model for generating descriptor images for images of one or more objects (e.g. a DON) is provided, in which a static (i.e. stationary, e.g. permanently mounted) camera can be used to record the images, i.e. training images are recorded that show a respective training scene from only one perspective. Training data for the machine learning model is generated by augmenting captured training images of the training scene. This is done in two (or multiple) ways, so that for each captured training image, the training data includes multiple augmented versions of the captured training image. Instead of determining pixels which correspond to one another or do not correspond to one another via geometrical correspondences of images from different perspectives (as in Reference 1), according to various embodiments, information about the used augmentations is used to determine which pixels correspond. Examples of augmentations (which make this possible and can therefore be used according to various embodiments) are random rotations, perspective and affine transformations. Unlike an affine transformation, a perspective transformation does not preserve parallelism. The image is transformed as if it were being viewed from a different viewing angle. This means that the image is virtually “tilted” (i.e. the side lengths are changed unequally and the space between them is interpolated).

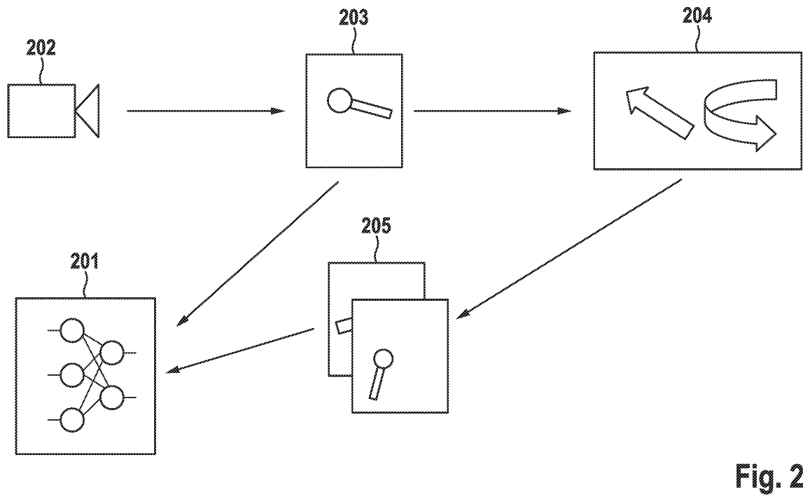

FIG. 2 shows a diagram illustrating a flow of data for training a machine learning model 201 for generating descriptor images for images of one or more objects.

A camera 202 (e.g. corresponding to the camera 114) takes a camera image 203 of an object 204. The camera image 203 is processed using one or more augmentations 204. The result is one or more augmented versions 205 of the camera image, e.g. two camera images from different perspectives (and different from that of the original camera image). The machine learning model 201 is trained using these and the original camera image 203, wherein camera images 203 can be recorded for different scenes and different objects and used for the training together with their augmented versions 205.

The training is thus carried out in a self-supervised manner, for example, using contrastive loss, see Reference 1 for an example.

An augmentation 204 can be seen as a (geometric) mapping of each pixel of the camera image 203 to a corresponding augmented version 205, i.e. each augmentation causes a change in position of pixel values. A pixel in the augmented camera image corresponds to another pixel in the original camera image if the augmentation has mapped the pixel value of the other pixel in the original camera image to it. Tracking this mapping (change in position) makes it possible to establish a correspondence between pixels of the camera image 203 and its augmentation 204 (or also between augmentations 204), i.e. determine pixels which correspond to one another (and consequently also object locations). Thus, positive pairs of pixels (which correspond to one another) and negative pairs of pixels (which do not correspond to one another) can be determined for contrastive learning. For each sampled positive pair, multiple negative pairs are sampled, for example. Pixels in two augmented versions of the camera image correspond to one another if they both correspond to the same pixel in the original camera image. The geometric augmentations can also be supplemented by downstream further augmentations (changes in color or brightness, noise, etc.) to increase the robustness of the machine learning model.

Along with the (e.g. RGB) camera images 203 (for different objects and/or scenes), the input data for the training method can also include associated object masks, which can, for example, be determined by comparing a depth image of a scene with an object to the depth image of the scene without the object (i.e. just the background).

Preprocessing can then be provided (prior to the augmentation 204), in which, in order to reduce the data volume of the camera images 203, the camera images are cropped to a smaller size, wherein the object mask is always taken into account so that the object is still included in the cropped camera image.

The augmentations are rotations and perspective and affine transformations, for example.

The output of the machine learning model 201 for an image fed to it, i.e. a (possibly cropped) camera image 203 or an augmented version 205 thereof, is a descriptor image with (for example) the same dimensions as the fed image but with a descriptor vector for each pixel instead of an RGB value. The machine learning model 201 is trained such that the descriptor vectors of two pixels belonging to the same original pixel (prior to augmentation), i.e. corresponding to one another, are close together. The descriptor vectors of pixels which do not correspond to one another, on the other hand, should be far apart in the descriptor space.

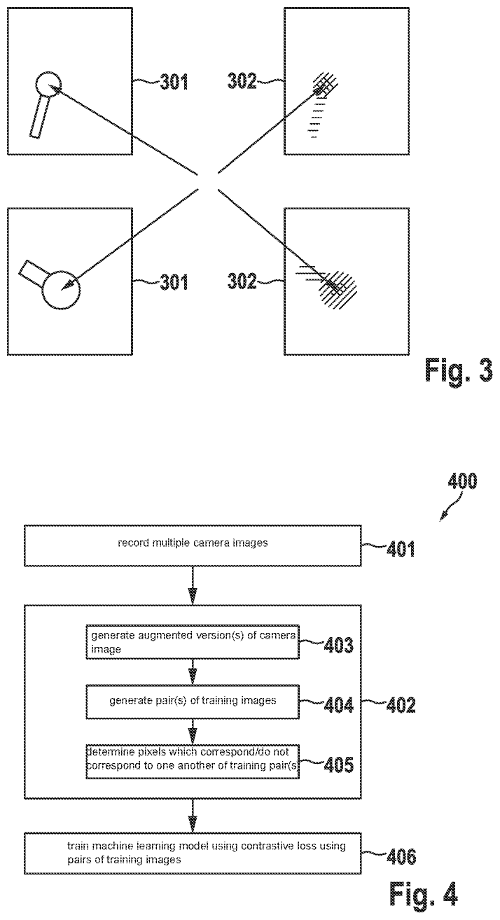

FIG. 3 shows two training data images 301, e.g. augmented versions 301 of a camera image. A location of the object 302 shown therein is sampled and the corresponding pixels in the two training data images 301 are determined from the knowledge of the augmentations. The two training data images 301 are mapped by the machine learning model to a respective descriptor image 302 (wherein different descriptor value ranges are shown here in a very simplified manner using hatching). The machine learning model is trained such that the descriptor values of the pixels are as close to one another as possible and as far away from the descriptor values of other pixels as possible (on average over many training images and sampled locations). The correspondence of pixels in the training data images 201 and the descriptor images 302 is indicated by the arrows.

One of the training data images 301 can also be the original camera image itself.

In summary, a method is provided according to various embodiments, as shown in FIG. 4.

FIG. 4 shows a flowchart 400 depicting a method for training a machine learning model for generating descriptor images for images of one or more objects, according to one embodiment.

In 401, multiple camera images are recorded, wherein each camera image shows one or more objects.

In 402, for each camera image,
in 403, one or more augmented versions of the camera image are generated by applying a respective augmentation to the camera image for each augmented version of the camera image, wherein the augmentation comprises a change in position of pixel values of the camera image;
in 404, one or more pairs of training images are generated, which each include the camera image and an augmentation of the camera image or two augmented versions of the camera image;
in 405, for each pair of training images, pixels which correspond to one another and pixels which do not correspond to one another of the pair of training images are determined according to the change in position of pixel values included in the augmentation with which the augmented version was generated, if the pair of training images includes an augmented version of the camera image, or, according to the changes in position of pixel values included in the two augmentations with which the augmented versions were generated, if the pair of training images includes two augmented versions of the camera image.

In 406, the machine learning model is trained using contrastive loss using the pairs of training images. Descriptor values which are generated by the machine learning model for pixels which correspond to one another are used as positive pairs and descriptor values which are generated by the machine learning model for pixels which do not correspond to one another are used as negative pairs.

It should be noted that the augmented versions are not necessarily created only after all the camera images have been recorded. This can also be done alternately, for example. The sequence is therefore not restricted to the sequence mentioned above.

The method of FIG. 4 can be carried out by one or more computers comprising one or more data processing units. The term “data processing unit” can be understood to mean any type of entity that enables the processing of data or signals. The data or signals can be treated according to at least one (i.e. one or more than one) specific function carried out by the data processing unit, for example. A data processing unit can comprise or be configured of an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described here in more detail can also be understood as a data processing unit or logic circuitry. One or more of the method steps described in detail here can be carried out (e.g. implemented) by a data processing unit by means of one or more specific functions executed by the data processing unit.

Using the trained machine learning model (e.g. using the trained machine learning model to determine an object pose or to determine locations to be processed) ultimately makes it possible to generate a control signal for a robot device. Relevant locations of any type of objects for which the machine learning model has been trained can be determined. The term “robot device” can be understood to refer to any physical system, e.g. a computer-controlled machine, vehicle, household appliance, power tool, manufacturing machine, personal assistant or access control system. A control rule for the physical system is learned, and the physical system is then controlled accordingly.

Images are recorded using an RGB-D (color image plus depth) camera, for example, processed by the trained machine learning model (e.g. neural network), and relevant locations in the workspace of the robot device are determined, wherein the robot device is controlled depending on the determined locations. An object (i.e. its position and/or pose) can be tracked in input sensor data for example.

The camera images are RGB images or RGB-D (color image plus depth) images, for example, but can also be other types of camera images such as (only) depth images or thermal, video, radar, LiDAR, ultrasound or motion images. Depth images are not absolutely necessary. The output of the trained machine learning model can be used to determine object poses, for example to control a robot, for example for assembling a larger object from sub-objects, moving objects, etc. The approach of FIG. 4 can be used for any pose determination method. Relevant locations determined from the descriptor images can be used, for example, to determine the position of locations of an object at which the object can be grabbed (or also sucked in) by a robot and those at which it should not be grabbed. They thus provide valuable information for a manipulation task, for example.

Although specific embodiments have been illustrated and described here, those skilled in the art in the field will recognize that the specific embodiments shown and described may be exchanged for a variety of alternative and/or equivalent implementations without departing from the scope of protection of the present invention. This application is intended to cover any adaptations or variations of the specific embodiments disclosed herein.

What is claimed is:

1. A method for training a machine learning model for generating descriptor images for images of one or more objects, the method comprising:
recording multiple camera images, each of the camera images showing one or more objects;
for each camera image of the camera images:
generating one or more augmented versions of the camera image by applying a respective augmentation to the camera image for each augmented version of the camera image, wherein the augmentation includes a change in position of pixel values of the camera image,
generating one or more pairs of training images which each include the camera image and an augmentation of the camera image or two augmented versions of the camera image, and
determining, for each pair of training images and from pixels of the pair of training image, according to the change in position of pixel values included in the respective augmentation with which the augmented version was generated, if the pair of training images includes an augmented version of the camera image, or, according to the changes in position of pixel values included in the two respective augmentations with which the augmented versions were generated, if the pair of training images includes two augmented versions of the camera image, pixels of the pair of training images which correspond to one another and pixels of the pair of training images which do not correspond to one another; and
training the machine learning model with contrastive loss using the pairs of training images, wherein descriptor values which are generated by the machine learning model for the pixels which correspond to one another are used as positive pairs and descriptor values which are generated by the machine learning model for the pixels which do not correspond to one another are used as negative pairs.

2. The method according to claim 1, wherein the augmentation includes a rotation, and/or a perspective transformation and/or an affine transformation.

3. The method according to claim 1, wherein, prior to generating the augmented versions and the pairs of training images, cropping the camera images taking into account object masks of the one or more objects.

4. The method according to claim 1, wherein the machine learning model is a neural network.

5. The method according to claim 1, wherein the plurality of camera images are recorded from the same perspective.

6. A method for controlling a robot to pick up or process an object, comprising the following steps:
training a machine learning model for generating descriptor images for images of one or more objects, including:
recording multiple camera images, each of the camera images showing one or more objects,
for each camera image of the camera images:
generating one or more augmented versions of the camera image by applying a respective augmentation to the camera image for each augmented version of the camera image, wherein the augmentation includes a change in position of pixel values of the camera image,
generating one or more pairs of training images which each include the camera image and an augmentation of the camera image or two augmented versions of the camera image, and
determining, for each pair of training images and from pixels of the pair of training image, according to the change in position of pixel values included in the respective augmentation with which the augmented version was generated, if the pair of training images includes an augmented version of the camera image, or, according to the changes in position of pixel values included in the two respective augmentations with which the augmented versions were generated, if the pair of training images includes two augmented versions of the camera image, pixels of the pair of training images which correspond to one another and pixels of the pair of training images which do not correspond to one another, and
training the machine learning model with contrastive loss using the pairs of training images, wherein descriptor values which are generated by the machine learning model for the pixels which correspond to one another are used as positive pairs and descriptor values which are generated by the machine learning model for the pixels which do not correspond to one another are used as negative pairs;
recording a camera image which shows the object in a current control scenario;
feeding the camera image which shows the object to the machine learning model to generate a descriptor image;
determining a position of a location for picking up or processing the object in the current control scenario from the descriptor image; and
controlling the robot according to the determined position.

7. The method according to claim 6, further comprising:
identifying a reference location in a reference image;
determining a descriptor of the identified reference location by feeding the reference image to the machine learning model;
determining a position of the reference location in the current control scenario by searching for the determined descriptor in the descriptor image generated from the camera image which shows the object; and
determining the position of the location for picking up or processing the object in the current control scenario from the determined position of the reference location.

8. A control unit configured to train a machine learning model for generating descriptor images for images of one or more objects, the control unit configured to:
record multiple camera images, each of the camera images showing one or more objects;
for each camera image of the camera images:
generate one or more augmented versions of the camera image by applying a respective augmentation to the camera image for each augmented version of the camera image, wherein the augmentation includes a change in position of pixel values of the camera image,
generate one or more pairs of training images which each include the camera image and an augmentation of the camera image or two augmented versions of the camera image, and
determine, for each pair of training images and from pixels of the pair of training image, according to the change in position of pixel values included in the respective augmentation with which the augmented version was generated, if the pair of training images includes an augmented version of the camera image, or, according to the changes in position of pixel values included in the two respective augmentations with which the augmented versions were generated, if the pair of training images includes two augmented versions of the camera image, pixels of the pair of training images which correspond to one another and pixels of the pair of training images which do not correspond to one another; and
train the machine learning model with contrastive loss using the pairs of training images, wherein descriptor values which are generated by the machine learning model for the pixels which correspond to one another are used as positive pairs and descriptor values which are generated by the machine learning model for the pixels which do not correspond to one another are used as negative pairs.

9. A non-transitory computer-readable medium on which are stored instructions for training a machine learning model for generating descriptor images for images of one or more objects, the instructions, when executed by a processor, causing the processor to perform the following steps:
recording multiple camera images, each of the camera images showing one or more objects;
for each camera image of the camera images:
generating one or more augmented versions of the camera image by applying a respective augmentation to the camera image for each augmented version of the camera image, wherein the augmentation includes a change in position of pixel values of the camera image,
generating one or more pairs of training images which each include the camera image and an augmentation of the camera image or two augmented versions of the camera image, and
determining, for each pair of training images and from pixels of the pair of training image, according to the change in position of pixel values included in the respective augmentation with which the augmented version was generated, if the pair of training images includes an augmented version of the camera image, or, according to the changes in position of pixel values included in the two respective augmentations with which the augmented versions were generated, if the pair of training images includes two augmented versions of the camera image, pixels of the pair of training images which correspond to one another and pixels of the pair of training images which do not correspond to one another; and
training the machine learning model with contrastive loss using the pairs of training images, wherein descriptor values which are generated by the machine learning model for the pixels which correspond to one another are used as positive pairs and descriptor values which are generated by the machine learning model for the pixels which do not correspond to one another are used as negative pairs.
